(19) United States
(12) Patent Application Publication
(10) Pub. No.: US 2013/0159148 A1
(43) Pub. Date: Jun. 20, 2013

(54) SYSTEM AND METHOD FOR AN ONLINE PROFIT CENTER AND SEGMENT DERIVATION

(71) Applicant: Radim Sykora, Nussloch (DE)

(72) Inventor: Radim Sykora, Nussloch (DE)

(73) Assignee: SAP AG, Walldorf (DE)

(21) Appl. No.: 13/325,271

(22) Filed: Dec. 14, 2011

(51) Int. Cl. G06Q 40/00

(52) U.S. Cl. 705/30

(57) ABSTRACT

A system and method are described herein that provide a system for deriving profit centers and segments during reporting instead of during posting. Reference objects are stored in posted documents and the derivation of the profit center and segment occurs dependently during the later stage of reporting, after the general ledger items have been extracted. A time dependent assignment of profit centers to reference objects is immediately visible in the balance sheet and/or income statement. The system and method further allow for an easy implementation for reorganization, where reorganization may even be implemented retroactively.

### FIELD OF THE INVENTION

The present invention relates to an online derivation of profit center and segments during reporting. The present invention further relates to a process for storing reference objects within a document and generating a time dependent assignment of profit centers to reference objects that are immediately visible in the balance sheet and/or income statement.

### BACKGROUND INFORMATION

A profit center may refer to a unit within a company or business that monitors overall costs and revenue of the business, but operates as an independent unit of the business. A profit center can determine internal profit and losses for certain areas of responsibility within a business. When certain analysis is undertaken of a business, such as a return on investment (“ROI”), this may be attributed on a balance sheet as being assigned to a profit center. This may be reflected in a profit center data sheet, which is a master table of all objects that have been assigned to the profit center. Examples of objects in a feeding document that may be assigned to a profit center include cost centers, internal orders, work breakdown structure (“WBS”) elements and other objects, such as cost objects.

When a profit center data sheet is active at the same time that a corresponding document is posted in a general ledger, the profit center data sheet is written together with the assigned objects in the document, at the time of posting. Some of the assigned objects, such as cost centers, may be time dependent, while other assigned objects are not.

FIG. 1 illustrates a previous implementation of the reporting of a profit center. The previous implementation may contain a feeding application 20. Feeding application 20 may post a document 10 to a general ledger. While document 10 is posted by feeding application 20, the profit center and corresponding segment are derived synchronously. Additionally, the previous implementation may contain master data 25 which contains a plurality of reference objects. These reference objects may be designated to be assigned to the profit center. When the document 10 is posted by the feeding application 20 and the profit center is derived, the reference objects in the master data 25 are assigned and stored in document 10. In a general ledger view of document 10, the document contains the stored profit center and segment.

In a general ledger view, document 10, containing the stored profit center and segment and assigned master data, can be separated into general ledger line items 30 and general ledger totals 35. The general ledger totals 35 from the general ledger view of posted document 10 can be used to generate a balance sheet or income statement 40.

The previous implementation becomes problematic especially in instances in which corporate reorganization or restructuring must be done. A reorganization or restructuring of a business requires the flexibility to be able to adjust the balance sheet or income statement accordingly. In instances in which a reorganization occurs, the underlying master data is also changed. A reorganization may result in, for example, a change of responsibilities in the assignments of reference objects to the profit centers. In some instances, for example, a cost center or internal order may require a reassignment to another profit center. In the previous implementation, in which the master data 25 was written to the document 10 and the profit center was derived at the time the document was posted, editing the reference objects to change the assignment is problematic. Any reorganization that results in a change in assignment requires a subsequent reposting of the balances in the general ledger and becomes a time-consuming and tedious process to undertake, because the processes are dependent upon each other. The reference objects that were posted to the old profit center subsequently require that they be posted to new profit centers.

FIG. 2 further illustrates the laborious process of reassignment of the reference objects to the profit center using the previous implementation of the reporting of a profit center. Any reassignment requires the use of additional logic. The implementation depicted in FIG. 2 contains reorganization logic 50 which has the task of reassigning various reference objects from the profit center. In this implementation, feeding application 20 contains transmission data pertaining to document 10 that was originally posted. This transmission data, including data about the profit center and corresponding segment, must be retrieved by the reorganization logic 50 because the system needs to know where the profit center or segment is coming from and to identify the first document in which the profit center was derived from. Subsequently, data corresponding to the reference objects of master data 25 is also retrieved by reorganization logic 50. This is necessary because the underlying master data was changed when the reorganization was made.

Any reorganization logic 50 must also retrieve the general ledger line items 30. This necessitates the reorganization logic 50 to analyze the transmitting data, reference objects, and existing general ledger line items to make the appropriate reassignments and to generate new ledger items. Only after doing this, can the reorganization logic 50 generate new general ledger line items 30 and general ledger totals 35 in the present implementation. The new general ledger totals can be used to generate a balance sheet or income statement. This entire process for updating the profit center and general ledger is inefficient and overly complex. The requirement for the use of additional logic increases the cost to make the assignment alterations.

Thus there remains a need in the art, for a system and method allowing for automatic reassignment of reference objects to a profit center in the event of a business reorganization. There also remains a need in the art, for a system and method which allows for derivation of the profit center and corresponding segment during reporting, rather than during posting of the document.

### SUMMARY OF THE INVENTION

A system and method are described herein that provide a system for deriving profit centers and segments during reporting instead of during posting. Reference objects are stored in posted documents and the derivation of the profit center and segment occurs dependently during the later stage of reporting, after the general ledger items have been extracted. A time dependent assignment of profit centers to reference objects is immediately visible in the balance sheet and/or income statement. The system and method further allow for an easy implementation for reorganization, where reorganization may even be implemented retroactively.

In particular, the exemplary embodiments and/or exemplary methods of the present invention are directed to a method for deriving profit centers and segments during reporting. This occurs through a process where at least one document from an application is posted on a user terminal, general ledger line items are stored from the at least one document in a repository, and the general ledger line items are selectively compared to reference objects classified in an assignment table. Furthermore, during a reporting stage, profit centers may be derived and each of the profit centers may be assigned to a respective reference object based on the assignment table. A balance sheet or income statement can be generated from the general ledger line items based on the assigned profit centers.

In the system and method, the profit centers and the segments are not derived when the at least one document is posted, but during the reporting stage. During a reorganization, at least one reference object may be reassigned to another profit center if selected by a user.

In the system and method, the assignment of each of the profit centers to the respective reference object is time dependent. The assignment of each of the profit centers to the respective reference object is immediately viewable in the generated balance sheet or income statement. Furthermore, reference objects are stored in the at least one document. The at least one document does not contain any information about the profit centers.

In the system and method, the general ledger line items are mapped to master data items. Furthermore, balance sheet or income statement is generated through an in-memory computing engine, like HANA appliance.

The exemplary embodiments and/or exemplary methods of the present invention are also directed to a method for adjusting balance sheet and income statements as a result of a reorganization. This method includes updating an assignment table to reflect a new assignment for a profit center based on the reorganization and assigning the reference object to another profit center as classified in the assignment table. The method also includes selectively comparing a general ledger line item to the new reference object in the assignment table and generating a new balance sheet or income statement from the general ledger line item based on the assigned profit center.

In this particular method, reorganization can occur retroactively or can be a simulation of a future reorganization. A new version of an entry in the assignment table is created to make the simulation.

The exemplary embodiments and/or exemplary methods of the present invention are also directed to an online profit center and segment derivation system. This system includes at least one user terminal having an application that posts at least one document and a repository for storing general ledger line items from the at least one document. This system also includes a processor that is provided to selectively compare the general ledger line items to reference objects classified in an assignment table and during a reporting stage, deriving profit centers. The processor is also configured to assign each of the profit centers to a respective reference object based on the assignment table and generate a balance sheet or income statement from the general ledger line items based on the assigned profit centers.

### BRIEF DESCRIPTION OF THE DRAWINGS

FIG. 1 is a diagram of a process of a previous implementation for deriving the profit center and corresponding segment.

FIG. 2 is a diagram of a process for reassigning reference objects from the profit center in the event of a business reorganization according to a previous implementation.

FIG. 3 is a diagram of an application for deriving the profit center and corresponding segment displayed on a user terminal according to an embodiment of the present invention.

FIG. 4 is a diagram of a system for deriving the profit center and corresponding segment according to an embodiment of the present invention.

FIG. 5 is a diagram of the mapping of the line items to the master data items according to an embodiment of the present invention.

### DETAILED DESCRIPTION

The subject invention will now be described in detail for specific preferred embodiments of the invention, it being understood that these embodiments are intended only as illustrative examples and the invention is not to be limited thereto.

Previous implementations for deriving profit centers and corresponding segments are inefficient and problematic, particularly in instances in which business reorganization is required. Any reorganization that results in a change in assignment requires a subsequent reposting of the balances in the general ledger, and a reposting of the reference objects to new profit centers, which is a long and laborious process. Exemplary embodiments of the present invention provide a system and method of an online profit center and segment derivation, in which derivation may occur during reporting, rather than posting. Reference objects may be stored in posted documents and the derivation of the profit center and segment may occur dependently during the later stage of reporting, after the general ledger items have been extracted. This may result in a new time dependent assignment of profit centers to reference objects that is immediately visible in the balance sheet and/or income statement. The system and method may further allow for an easy implementation for reorganization, where reorganization may even be implemented retroactively.

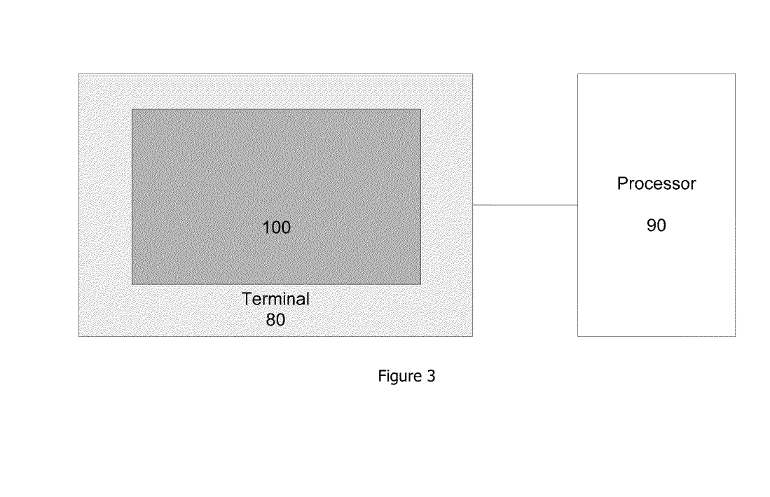

FIG. 3 illustrates a diagram of an application for deriving the profit center and corresponding segment displayed on a user terminal according to an embodiment of the present invention. Application 100 may be executed, for example, by a processor 90 and may be displayed on user terminal 80 to a user. User terminal 80, may be embodied, for example, as a desktop, laptop, hand-held device, personal digital assistant (PDA), television set-top Internet appliance, mobile telephone, smart phone, iPod™, iPhone™, iPad™, etc., or as a combination of one or more thereof, or other comparable device.

In an example embodiment, application 100 may be a web application that is implemented on a back end component and displayed on a user interface on user terminal 80. In another embodiment, the application may be a computer-based application stored locally and displayed on terminal 80. In another embodiment, application 100 may be an application specifically designed and configured for a hand-held device, mobile telephone, smart phone, iPod™, iPhone™, or iPad™.

In an example embodiment, the system and method may include one or more processors 90, which may be implemented using any conventional processing circuit and device or combination thereof, e.g., a central processing unit (CPU) of a personal computer (PC) or other workstation processor, to execute code provided, e.g., on a hardware computer-readable storage medium including any conventional memory device, to perform any of the methods described herein, alone or in combination. The memory device may include any conventional permanent and/or temporary memory circuits or combination thereof, a non-exhaustive list of which includes Random Access Memory (RAM), Read Only Memory (ROM), Compact Disks (CD), Digital Versatile Disk (DVD), and magnetic tape.

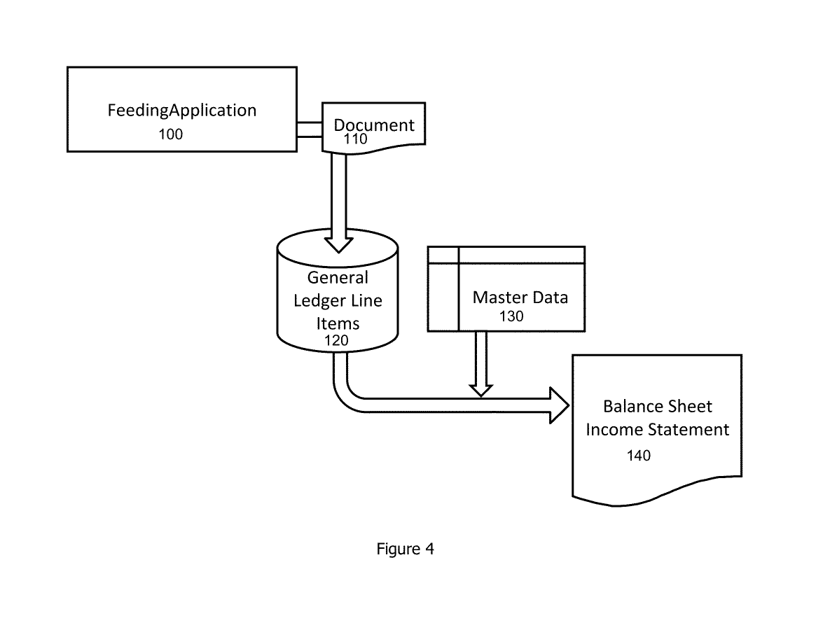

FIG. 4 illustrates a system for deriving the profit center and corresponding segment after reporting. The system may include an application 100 that may be displayed on user terminal 80 and executed by processor 90. The system may also include document 110, which may contain financial information about a various business or company. Document 110 may be used to obtain various financial information about the specific business, and may be used to compile the general ledger items on the general ledger. Document 110 may not contain information about the profit center or segment information written into the document.

The system illustrated in FIG. 4 may also include a repository or database for the general ledger line items 120 which may store general ledger line items that were obtained from document 100. The general ledger line items may be retrieved from the repository general ledger line items 120 in order to later generate the balance sheet or income statement 140. A balance sheet or income statement 140, both of which may be generated from the general ledger line items, may be displayed on the interface on user terminal 80.

Master data for the system may include reference objects such as WBS elements, cost centers, and/or internal orders. Each of these reference objects may be assigned to a derived profit center, and assignment may take place during the derivation of the profit center and/or corresponding segment. The reference objects and the specific assignments to the profit centers may be arranged accordingly in the assignment table 130. The assignment table 130 is advantageous because assignments between the reference objects and the corresponding profit centers may be readily changed. The assignment table 130 may also include information pertaining to date and time in order to have the derivation of the profit centers be time dependent.

During operation, application 100 may post at least one document 110. In an alternate embodiment, the system may select and retrieve a plurality of documents sequentially from a designated time frame, for example, from the beginning of a calendar year. This may advantageously allow for a user to search through a collection of documents. Document 110 may be viewed in a general ledger layout, and general ledger line items may be stored in the repository for the general ledger line items 120. In an embodiment, the general ledger line items may represent an aggregate of a collection of documents, the line items of which may be stored in the repository. Document 110 may not contain any information about the profit center or corresponding segment when it is in the general ledger layout.

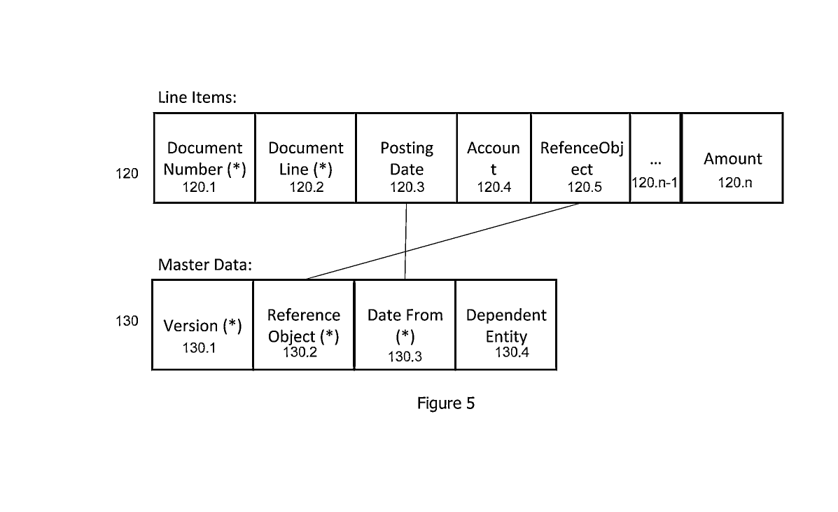

Each line item in repository 120 or from the general ledger layout may be selected individually. Upon selection of a general ledger line item, the system may look at assignment table 130. The system may check to see if a reference object corresponds to the selected line item, as further illustrated in FIG. 5. If a reference object does correspond to the selected line item, a profit center may be derived, and a reference object may be assigned to the profit center based on the assignment table 130. This may be done for each line item on the general ledger in order to generate the balance sheet or income statement 140. Once all assignments have been made in accordance with the assignment table, the balance sheet or income statement 140 may be displayed on the user terminal 80.

FIG. 5 illustrates a diagram of the mapping of the line items of the general ledger to the master data items according to an embodiment of the present invention. The general ledger line items 120 may include a number or classifying data keys for each line item. These keys may include, but are not restricted to: “Document Number” 120.1, “Document Line” 120.2, “Posting Date” 120.3, “Account” 120.4, “Reference Object” 120.5, and “Amount” 120.n.

The master data in derivation chart 130 may also include information that is broken down into distinct classifying data keys for each entry. These keys may include, but are not restricted to: “Version” 130.1, “Reference Object” 130.2, “Date From” 130.3, and “Dependent Entity” 130.4.

When the system checks to see if a reference object corresponds to the selected line item, some of the line item keys may be mapped to the master data keys. For example, for a general ledger line item having a specific date as the “Posting Date” date 120.3, this date may be used for the corresponding master data for a “Date From” date 130.3. Additionally the “Reference Object” 120.5 of the line item may be mapped to the “Reference Object” 130.2 of the master data, as illustrated in FIG. 5.

Reporting may be done directly from the general ledger line items using High-Performance Analytic Appliance (“HANA”) modeling to generate the balance sheet and income statement. HANA modeling may allow direct modeling via an in-memory computing engine where business data that is to be processed is stored in RAM instead of being read from discs or a flash drive. This may lead to a higher performance from the modeling process than using other traditional modeling processes for reporting.

Because the profit centers and corresponding segments may be not derived until reporting, the time dependent assignment of the profit centers to the reference objects may be immediately visible in the corresponding balance sheet or income statement 140. The assignment may be viewed in the balance sheet or income statement 140 without a need to repost the reference objects to the derived profit centers or to repost the balances in the general ledger. This may be particularly important in instances that may require further reorganization. The embodiment depicted in FIG. 4 may allow for a structured reorganization without a complex process that requires identification of the prior document from where the profit center was first derived.

The system of the present invention may also allow for the incorporation of past and future reorganizations, rather than just present restructuring. In an example embodiment, the system may allow for a simulation of a reorganization. Assignment table 130 may be altered to reflect potential future restructuring and each of the line items of the general ledger may again be selected and checked against the simulated assignment table. Balance sheet or income statement 140 may be generated to reflect the hypothetical assignments between the reference objects and new profit centers as determined by assignment table 130. This may advantageously provide a company the ability to analyze possible effects on the balance sheet or income statement from proposed reorganization.

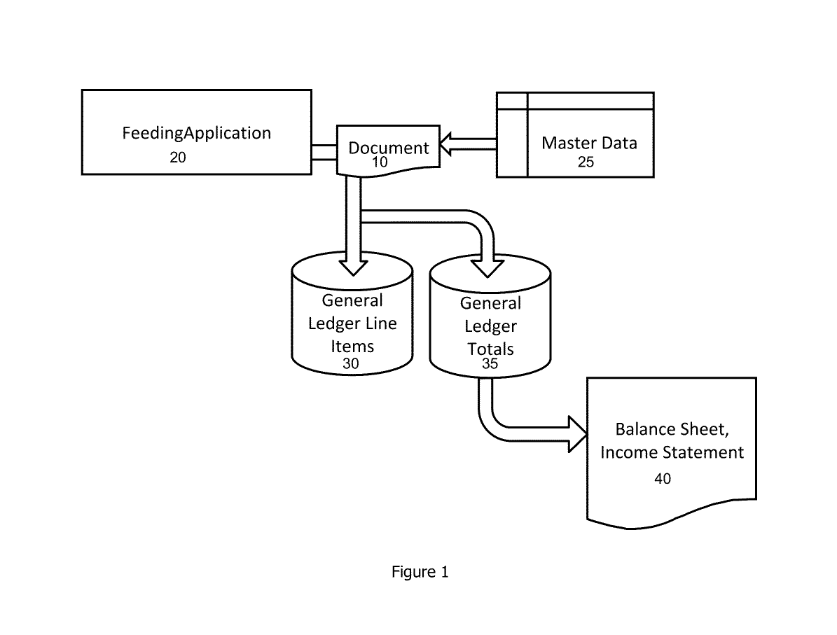

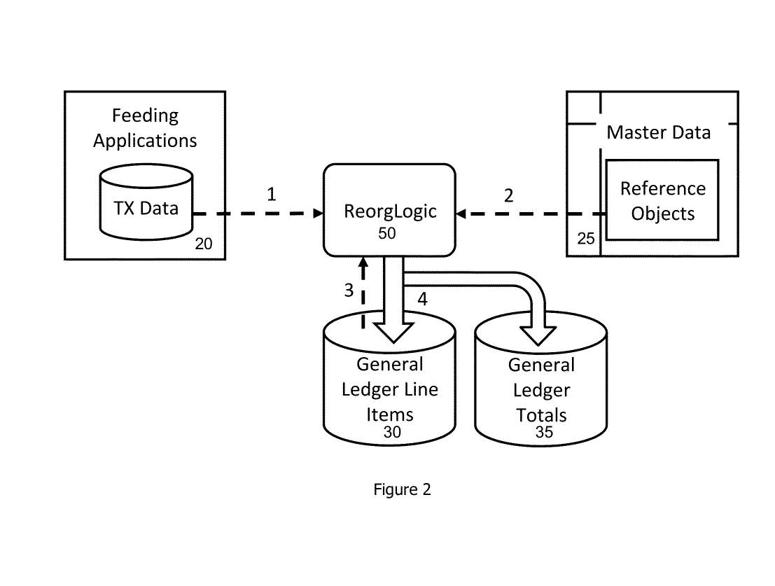

The online profit center derivation system depicted in FIG. 4 may also allow for the incorporation of a retrospective reorganization. For example, a company may introduce a reorganization effective on Jan. 6, 2012. However, the same company may require that the reorganization apply to the accounting retrospective to Jan. 1, 2012. The embodiments in FIGS. 1 and 2 may not allow for this restructuring. The system as depicted in FIG. 4, may have the advantageous affect that a reorganization may be implemented retroactively and this may be reflected on the balance sheet or income statement 140. This may be achieved by creating a new entry under the key for “Version” in the assignment table 130. This new “Version” in the assignment table 130 may have a “Date From” date 130.3 that is separate and distinct from the “Posting Date” date 120.3 of the line item. The user may enter a desired “Date From” date to apply the retroactive reorganization.

Several embodiments of the invention are specifically illustrated and/or described herein. However, it will be appreciated that modifications and variations of the invention are covered by the above teachings and within the purview of the appended claims without departing from the spirit and intended scope of the invention.

What is claimed is:

1. A method for deriving profit centers and segments during reporting, the method comprising:
posting at least one document from an application on a user terminal;
storing general ledger line items from the at least one document in a repository;
selectively comparing the general ledger line items to reference objects classified in an assignment table;
during a reporting stage, deriving the profit centers;
assigning each of the profit centers to a respective reference object based on the assignment table; and
generating a balance sheet or income statement from the general ledger line items based on the assigned profit centers.

2. The method according to claim 1, wherein the profit centers are not derived when the at least one document is posted.

3. The method according to claim 1, wherein the segments are derived during the reporting stage.

4. The method according to claim 1, wherein each of the profit centers may be reassigned to another reference object.

5. The method according to claim 1, wherein the assignment of each of the profit centers to the respective reference object is time dependent.

6. The method according to claim 1, wherein the reference objects are stored in the at least one document.

7. The method according to claim 1, wherein the at least one document does not contain any information about the profit centers.

8. A method for adjusting balance sheet and income statements as a result of a reorganization, the method comprising:
updating an assignment table to reflect a new assignment for a profit center based on the reorganization;
assigning the profit center to a new reference object as classified in the assignment table;
selectively comparing a general ledger line item to the new reference object in the assignment table; and
generating a new balance sheet or income statement from the general ledger line item based on the assigned profit center.

9. The method according to claim 8, wherein the reorganization occurred retroactively.

10. The method according to claim 8, wherein the reorganization is a simulation of a future reorganization.

11. The method according to claim 10, wherein a new version of an entry in the assignment table is created to make the simulation.

12. An online profit center and segment derivation system, the system comprising:
at least one user terminal having an application that posts at least one document;
a repository for storing general ledger line items from the at least one document; and
a processor providing the following:
selectively comparing the general ledger line items to reference objects classified in an assignment table;
during a reporting stage, deriving profit centers;
assigning each of the profit centers to a respective reference object based on the assignment table; and
generating a balance sheet or income statement from the general ledger line items based on the assigned profit centers.

13. The system according to claim 12, wherein the profit centers are not derived when the at least one document is posted.

14. The system according to claim 12, wherein each of the profit centers may be reassigned to another reference object.

15. A computer system for deriving profit centers and segments during reporting, the computer system comprising:
a processor;
a user terminal coupled to the processor; and
a memory storing executable code comprising instructions to:
post at least one document from an application on a user terminal;
store general ledger line items from the at least one document in a repository;
selectively compare the general ledger line items to reference objects classified in an assignment table;
during a reporting stage, derive the profit centers;
assigning each of the profit centers to a respective reference object based on the assignment table; and
generate a balance sheet or income statement from the general ledger line items based on the assigned profit centers.

16. The computer system according to claim 15, wherein each of the profit centers may be reassigned to another reference object.

17. A computer system configured to adjust balance sheet and income statements as a result of a reorganization, the computer system comprising:
a processor;
a user terminal coupled to the processor; and
a memory storing executable code comprising instructions to:
update an assignment table to reflect a new assignment for a profit center based on the reorganization;
assign the profit center to a new reference object as classified in the assignment table;
selectively compare a general ledger line item to the new reference object in the assignment table; and
generate a new balance sheet or income statement from the general ledger line item based on the assigned profit center.

18. A computer readable medium having a computer program which is executable by a processor for deriving profit centers and segments during reporting, the computer readable medium comprising:
an arrangement providing the following:
posting at least one document from an application on a user terminal;
storing general ledger line items from the at least one document in a repository;
selectively comparing the general ledger line items to reference objects classified in an assignment table;
during a reporting stage, deriving the profit centers;
assigning each of the profit centers to a respective reference object based on the assignment table; and
generating a balance sheet or income statement from the general ledger line items based on the assigned profit centers.

19. The computer readable medium according to claim 18, wherein each of the profit centers may be reassigned to another reference object.
